(19) United States
(12) Patent Application Publication
(10) Pub. No.: US 2020/0367531 A1
(43) Pub. Date: Nov. 26, 2020

(54) RUMINAL PROTECTION OF LIPIDS, LIPID-BEARING MATERIALS, AND BIOACTIVE ALIMENTS

(71) Applicant: Russell W. DAY, Tualatin, OR (US)

(72) Inventor: Russell W. DAY, Tualatin, OR (US)

(21) Appl. No.: 16/992,027

(22) Filed: Aug. 12, 2020

Related U.S. Application Data
(63) Continuation of application No. 15/897,058, filed on Feb. 14, 2018.
Application No. 15/897,058 is a continuation-in-part of application No. PCT/US2016/046930, filed on Aug. 12, 2016.
(60) Provisional application No. 62/205,308, filed on Aug. 14, 2015.

(51) Int. Cl. A23K 40/35; A23K 20/147; A23K 20/158; A23K 50/10; A23K 20/189

(52) U.S. Cl. CPC A23K 40/35; A23K 20/147; A23K 20/189; A23K 50/10; A23K 20/158

(57) ABSTRACT

Compositions and related methods are provided to protect lipids such as oilseeds and algae, and other bioactive aliments from ruminal degradation. The lipids are protection by creating a matrix of cross-linked and denatured proteins using enzymes and other protein crosslinking agents.

### BACKGROUND

Polyunsaturated fats are known to have a beneficial effect for the humans and animals that consume them. In humans, particular emphasis is currently being placed on the ratio of omega 3 to omega 6, because in recent decades consumption of omega 6 has skyrocketed, resulting in imbalances. Furthermore, it is well settled that sufficient omega 3 is necessary for vision, heart function, brain function, reproduction, and general cellular structure such as phospholipids. Similar needs are extant with livestock. For example, reproductive efficiency in dairy cattle will increase significantly when they have sufficient omega 3 in the bloodstream.

Ruminants, such as cattle, sheep, and goats, have a digestive system consisting of four compartments prior to the intestines. This setup allows them to eat and digest feeds high in cellulose, like grass, from which monogastrics, such as pigs and chickens, would gain little nutritive value. The rumen is the first and most distinctive of the four compartments. In the rumen, an ecosystem of microorganisms metabolizes cellulose into volatile fatty acids, providing energy to the animal which is used in growth and milk production.

The University of Minnesota Dairy Extension reports on its website that: Rumen micro-organisms change unsaturated fatty acids to saturated acids through the addition of hydrogen molecules. Thus, more saturated fat is absorbed by cows than by simple-stomach animals. Feeding large quantities of unsaturated fatty acids can be toxic to rumen bacteria, depress fiber digestion, and lower rumen pH.

Accordingly, neither the animal nor the consumer of those animal products gain maximum health benefits when unsaturated fats are fed to ruminants. And rumen digestion is negatively impacted by too much unsaturated fat.

What is needed is a material composition and method that allows polyunsaturated fats to bypass the rumen so that the healthy nature of the lipid is preserved, and rumen function is not adversely affected. Furthermore, the feed needs to digest later in the gastrointestinal tract so that the nutrients can be absorbed from the small intestine into the bloodstream, from which the animal will gain the benefits and the animal products will be enriched with such polyunsaturated fats.

Recognizing this biohydrogenation problem, research has been done wherein various polyunsaturated fats have been fed via fistulation directly to the intestines or abomasum of a ruminant to determine effect. Fistulation and direct feeding to the intestines or abomasum bypasses the rumen and the biohydrogenation problem. In such tests, both meat and milk have shown significant improvements in their fatty acid profile, with more polyunsaturated fats such as omega 3's.

Many attempts have been made to create a feed constituent that will bypass lipids through the rumen with the result of creating healthier meat and dairy. Some of the methods attempted include:
Formaldehyde treatment
Calcium salts of fatty acids
Gels
Applying alkali then acids on emulsified lipid and protein mixtures
Extruded or Micronized oilseeds, such as flax

Formaldehyde treatments were pioneered in the 1970's. Oilseeds such as canola, soybean, sunflower, and flax were treated with formaldehyde, which cross-linked the endogenous proteins of the seed, and successfully bypassed the rumen. Milkfat from cows fed sufficient amounts of formaldehyde-treated oilseeds had a different and more beneficial fatty acid profile. However, regulatory agencies, such as the United States' EPA, consider formaldehyde a probable human carcinogen. The use of formaldehyde-based products to alter milkfat profile has not been commercially feasible because of liability and consumer acceptance issues.

Calcium salts of fatty acids are fatty acids that have been reacted with calcium to create a fat-based feed that is mostly rumen inert. In the early 1980's this technology was developed and commercialized. Rumen inert is different than rumen bypass. Rumen inert calcium salts lessen many of the negative effects that unprotected fats can have on the cow, such as feed intake suppression, lower digestibility of forages, and milkfat depression. However, biohydrogenation (saturation of fats in the rumen) still occurs. Calcium salts are not capable of increasing the amount of omega 3 in the milk sufficient for commercial implementation. The main use of calcium salts remains as an energy source during peak lactation for dairy cattle. See Chouinard et al, Journal of Dairy Science (JDSA) 81:471-481 (1998). Another disadvantage of calcium salts is palatability. Cattle often avoid or refuse calcium salts due to taste.

In 2006 Carroll et al. (JDSA 89:640-650) showed that a gel made of whey protein is capable of ruminally protecting polyunsaturated fats to the extent that the resulting milkfat is significantly different than commercial averages. However, this technology has not been commercially implemented. The gel must be fed very soon after production, or it must be stored in cans or another method of preservation. In either case, the practicality of feeding gel on a commercial scale is very difficult. Furthermore, the whey proteins on which the gel is based are expensive, making the product doubly challenging for commercial use.

U.S. Pat. No. 5,514,388 posits the use of alkali followed by acids on emulsified lipid and protein mixtures to encapsulate and protect lipids, including claimed ruminal protection. No publications have confirmed effectiveness of ruminal protection by this approach, and it has not been commercially implemented.

Micronized and extruded oilseeds have not been shown to significantly increase ruminal bypass over ground or whole flaxseed. Data from the Gonthier et al. study, shown below in Table 1, illustrate the point.

Prior uses of transglutaminase for protection of ruminant feed have been specific to preventing proteolysis of the proteins, including during ensileage, and have relied on the chemistry aspect wherein the cross-linked proteins are ruminally inert. For example, the use of protein crosslinking agents as a method of preserving sileage and ruminal protein protection has been addressed in International Application No. PCT/EP1999/003356, which was published as Publication No. WO1999057993 A1. However, the objective of technology described in Publication No. WO1999057993 A1 relates to avoidance of proteolysis both in storage and in the rumen and focuses on the protection of proteins in silage for ruminants.

Another publication focuses on a food grade product to microencapsulate fish oil for human consumption. Encapsulation of Fish Oil by an Enzymatic Gelation Process Using Transglutaminase Cross-linked Proteins (Cho et al, Journal of Food Science Vol. 68 Nr. 9, 2717-2723, 2003). It states that microcapsules “had a narrow particle-size range (30 to 60 microns) with relatively uniform distribution”. The publication focuses on fish oil and protein isolates, which are quite expensive, and the publication posits a food product for humans. Additionally, the publication teaches a challenging and expensive double gelation process and production of small, uniform microcapsules.

In contrast to human consumption, fish oil in ruminants can be highly problematic. In the rumen, polyunsaturated fats have a toxic effect to rumen microflora. The more unsaturated and longer the lipid is, the worse the effect. Of all lipid sources, fish oils have among the longest and most unsaturated lipids. When such lipids are unprotected in the rumen the effect can be devastating on feed intake, feed digestion, milk production, and milkfat suppression. If fish oil is to be fed to ruminants, it needs to be well protected and tested carefully.

Many feeding tests have been conducted in attempts to understand and demonstrate improvements in milkfat profile, with focus on an omega 3 fatty acid, Alpha Linolenic Acid (ALA, 18:3 n3, the main lipid found in flaxseed). The following table, Table 1, shows two key data points for various attempts. Data is from three sources:
Gonthier et al. at McGill University, and published in the Journal of Dairy Science, 88:748-756 (2005)
Chouinard et al., Journal of Dairy Science (JDSA) 81:471-481 (1998)
Moats, Janna, Effects of Extruded Flaxseed and Condensed Tannins on Rumen Fermentation, Omasal Flow of Nutrients, Milk Composition and Milk Fatty Acid Profile in Dairy Cattle, Thesis Submitted to the College of Animal and Poultry Science, University of Saskatchewan, published on Feb. 2, 2016.
   The two key data points are listed in the table including:

1. The efficiency of the transfer, which is determined by calculating how much of the α-linolenic acid (ALA) that was fed to the cow transited to the milk.

2. The absolute results are measured based on the amount of ALA as a percentage of milkfat in the milk.

TABLE 1
Key Data Points for Currently Available Products

| | Dietary | Efficiency | ALA as % |
|---|---|---|---|
| Study | Treatment | of Transfer | of Milkfat |
| Gonthier | Control | N/A | 0.4% |
| Gonthier | Raw, ground flaxseed | 2.00% | 1.3% |
| Gonthier | Micronized flaxseed | 2.20% | 1.3% |
| | (“micronized” means | | |
| | heated to 115° C. | | |
| | for 90 seconds, | | |
| | with disrupted seedcoat) | | |
| Gonthier | Extruded flaxseed | 0.90% | 0.7% |
| | (heated to 155° C. for | | |
| | 43 seconds, with | | |
| | disrupted seedcoat) | | |
| Chouinard | Control | N/A | 0.24% |
| Chouinard | Calcium Salt of Linseed Oil | 0.96% * | 0.31% |
| Moats | Control | N/A | 0.43% |
| Moats | Linpro (flax extruded | 2.81% * | 0.95% |
| | with peas and alfalfa) | | |
| Moats | Linpro-Faba (flax extruded | 2.80% * | 0.98% |
| | with faba beans and alfalfa) | | |

* Data calculated based on results reported in the study

For currently existing commercial products, results shown in Table 1 are representative of, and consistent with, other studies in which efficiency of transfer remains below 2.9%, and ALA as a percent of milkfat rarely rises above 1.3%, no matter what feed supplement or feeding scheme is used. Note that milkfat profile generally is determined by following AOAC Official Method 996.06, however each peer reviewed study indicates their specific methodology.

Because cows cannot synthesize ALA, the increase of ALA in the milkfat can be used as a proxy to prove that ALA successfully transited the rumen without alteration. This is a well-known fact among those versed in the ways of ruminant nutrition. As shown earlier from the University of Minnesota website “Rumen micro-organisms change unsaturated fatty acids to saturated acids through the addition of hydrogen molecules.” But not all ALA that escapes the rumen goes into the milk. ALA is also utilized for other metabolic processes in the cow.

### SUMMARY

The present disclosure provides for a cross-linked protein matrix that protects bioactive aliments including lipid-bearing materials such as oilseeds and algae, from ruminal degradation. The mechanism for creating the protein matrix involves use of protein crosslinking agents.

Ruminal protection occurs because cross-linked and denatured proteins form a physically durable matrix that withstands mastication and ruminal microflora, thus providing ruminal protection for oilseeds, algae, lipids, proteins, nutraceuticals, pharmaceuticals, and other bioactive aliments. Proteins are used with sufficient quality, quantity, and easy commercial availability, including exogenous proteins when necessary, to form the protective matrix.

The compositions and methods disclosed in this patent application overcome all the drawbacks found in the prior art. The cross-linked proteins ruminally protect bioactive aliments such as polyunsaturated fats in a protein matrix. The proteins and lipids are of common and commercially viable oilseeds such as soy, canola, flax, sunflower, cottonseed, sunflower, camelina, etc. can be utilized. The end product can be in the form of a dried noodle, crumble, or pellet which has a long shelf life, is easy to store, and is easy to include in rations of commercial operations. Palatability is good.

In one embodiment, a method of preparing a ruminally protected composite material may comprise pulverizing a lipid-bearing material, which includes lipids; mixing a proteinaceous material, which includes proteins, an enzymatic protein crosslinking agent, and the pulverized lipid-bearing material to yield a mixture; molding the mixture to yield feed in a physical form factor conducive to drying, transport, storage, and feeding; and drying the feed. The form feed has a matrix configured such that the lipid-bearing material is at least partially entrained within the matrix and such that a portion of the lipids in the lipid-bearing material is protected from ruminal degradation.

The method may also involve mixing the enzymatic protein crosslinking agent with water prior to being mixed with the proteinaceous material and the pulverized lipid-bearing material. The water may be heated prior to being mixed with the enzymatic protein crosslinking agent. The lipid-bearing material and the proteinaceous material may be mixed together prior to being mixed with the enzymatic protein crosslinking agent. The lipid-bearing material may be heated prior to being added to the mixture while the proteinaceous material may be at ambient temperature prior to being added to the mixture.

The mixture may have a dwell time up to about twenty-four hours prior to being molded. The feed may be dried by being heated.

Pulverizing a lipid-bearing material enables a majority of the pulverized lipid-bearing material to pass through a sieve having 0.6 mm openings and at least about 95% of the pulverized lipid-bearing material to pass through a sieve having 1.18 mm openings. This size is advantageous during mastication.

The lipids and the proteins may be present in a ratio ranging from about 2:1 of lipid to protein to about 1:6 lipid to protein. Additionally, the lipid-bearing material and the proteinaceous material may be present in a ratio ranging from about 10:1 of lipid-bearing material to proteinaceous material to about 1:2 lipid-bearing material to proteinaceous material.

The proteinaceous material may be exogenous to the lipid-bearing material. Additionally, the lipid-bearing material and proteinaceous material come from a single source that is at least one of an oilseed, phytoplankton, algae, fish, krill, marine offal, or animal offal.

The lipid-bearing material may be at least one of phytoplankton, algae, fish, krill, marine offal, animal offal. The lipid-bearing material may be an oilseed. Examples of suitable oilseeds include soya bean, flax, safflower, sunflower, rapeseed, canola, mustard seed, camelina, nuts, peanuts, hemp, chia, or echium.

The proteinaceous material may be at least one of algae, phytoplankton, blood, offal, feathers, meat meal, legumes, alfalfa, or gelatin. The proteinaceous material may be an oilseed such as at least one of soya bean, flax, safflower, sunflower, rapeseed, canola, mustard seed, camelina, nuts, peanuts, hemp, chia, or echium.

The crosslinking agent may be transglutaminase. The crosslinking agent may also be at least one of protein disulphide isomerase, protein disulphide reductase, sulphydryl oxidase, lysyl oxidase, peroxidase, or glucose oxidase.

In one embodiment, a ruminant animal feed comprises a proteinaceous material that includes enzymatically cross-linked and denatured proteins in a matrix; and a lipid-bearing material that includes lipids. The lipids and the proteins are present in a ratio ranging from about 2:1 of lipid to protein to about 1:10 lipid to protein. The lipid-bearing material and the proteinaceous material are intermixed such that the lipid-bearing material is at least partially contained within the matrix and such that a majority of the lipids in the lipid-bearing material is protected from ruminal degradation. In one embodiment, the lipid-bearing material is flaxseed and the proteinaceous material is soy. In another embodiment, the lipid-bearing material is canola and the proteinaceous material is soy. In an additional embodiment, the lipid-bearing material is canola and flaxseed and the proteinaceous material is soy. The lipid-bearing material may be sized such that a majority passes through a sieve having 0.6 mm openings and at least about 95% of the lipid-bearing material passes through a sieve having 1.18 mm openings.

A method is also disclosed of modifying the fatty acid profile in milkfat, comprising feeding a ruminant any of the compositions disclosed herein the ruminant yields omega 3 as a percent of milkfat that is greater than about 1.3%, greater than about 2%, greater than about 2.5%, and that is at least about 3%. A method is additionally disclosed for modifying the fatty acid profile in meat or fat comprising by feeding a ruminant any of the feed compositions disclosed herein.

### DETAILED DESCRIPTION

The compositions and methods disclosed herein permit many options for preparing ruminally protected feeds. The compositions may be prepared by following an outline or menu of options or steps. The outline is representative, not exclusive. After the outline, each of the steps is explained in more detail.

Steps:

1. Choose the desired outcome
a. Select the main substrate(s)
b. Select what other components will be included
c. Determine what proteins will be necessary
d. Determine the amount of crosslinking agent
e. Determine the amount of water

2. Prepare the substrates and ingredients
a. Particle size
b. Dispersion
c. Heating

3. Mix and crosslink proteins
a. Special handling cases
b. Dwell time

4. Form and dry

These four steps provide a representative menu. The following paragraphs explain each step in more detail.

Step 1—Choose the Desired Outcome.

Possible desired outcomes stemming from the present disclosure include, but are not limited to:
Improved lipid profile of dairy and beef, or improved lipid profile for any ruminant animal products
Improved economic results on dairy farms due to better pregnancy rates by increasing bio-availability of omega 3 lipids
Feeding vitamins or medications that need ruminal protection.
Increased milk production due to higher caloric intake, especially via increase intake of lipids

Step 1a—Choose the Main Substrate(s).

The following table lists some suitable substrates. These substrates include proteinaceous materials and lipid-bearing materials. This list is representative, not exclusive.

| Source | Lipids |
|---|---|
| Algae and/or | Docosohexanoic acid (DHA 22:6, n-3), |
| algae lipids | Eicosapentanoic acid (EPA 20:4, n-3), |
| | Arachidonic acid (ARA 20:4 n-6), |
| | others |
| Flax and/or | Alpha-linolenic (ALA 18:3, n-3), |
| flax oil | Linoleic acid (LA 18:2, n-6), |
| | Oleic acid (18:1, n-9) |
| Canola and/or | Oleic acid (18:1, n-9), |
| canola oil | Linoleic acid (LA 18:2, n-6), |
| | Alpha-linolenic (ALA 18:3, n-3) |
| Soya and/or | Linoleic acid (LA 18:2, n-6), |
| soy oil | Alpha-linolenic (ALA 18:3, n-3), |
| | others |
| Sunflower and/or | Linoleic acid (LA 18:2, n-6), |
| sunflower oil | Oleic acid (18:1, n-9) |
| Safflower and/or | Linoleic acid (LA 18:2, n-6), |
| safflower oil | Oleic acid (18:1, n-9) |
| Camelina and/or | Alpha-linolenic (ALA 18:3, n-3), |
| camelina oil | Linoleic acid (LA 18:2, n-6), |
| | Oleic acid (18:1, n-9), |
| | Gondoic (20:1, n-9), others |
| Krill, fish, fish | Docosohexanoic acid (DHA 22:6, n-3), |
| processing offal, | Eicosapentanoic acid (EPA 20:5, n-3), |
| or other marine | others |
| sources of lipids | |

Step 1b—Choose What Other Components Will be Included.

Additives that may be utilized generally fall into categories of
Preservatives, such as tocopherols, polyphenols, ethoxyquin, and/or other antioxidants.
Bioactive aliments, such as lipid soluble vitamins, other vitamins, nutraceuticals, pharmaceuticals, enzymes, minerals, etc.
Palatability agents, such as molasses, lactose, other sugars, salt, spices, herbs, etc.

Step 1c—Determine What Proteins Will be Necessary.

The quality and quantity of exogenous protein depends on what proteins, if any, come with the lipid source. In some embodiments, the lipids and the proteins are present in a ratio ranging from about 2:1 of lipid to protein to about 1:10 lipid to protein. Often a one-to-one protein to lipid ratio will be sufficient for ruminal protection provided that the protein has an acceptable amino acid profile. In some cases, less protein will be sufficient. Soy flour is a preferred source of protein due to easy commercial availability and an advantageous mix of amino acids. For example, CHS of Mankato, Minn. produces HoneySoy, which is a soy flour with guaranteed 50% protein content and 90% solubility.

It is not always required to add exogenous protein. For example, many oilseeds consist of both lipids and proteins. On average, whole soybeans are 20% lipid and 36% protein. Soybeans may be processed under the present disclosure without exogenous protein. Canola and flax, by comparison, average 40% lipid and 20% protein. Canola and flax can achieve a certain level of ruminal protection without exogenous protein, however in practice these two oilseeds do better with added protein.

One factor to consider when selecting a protein is the volume of crosslinking amino acids. For example, the enzyme transglutaminase (TG) cross links lysine and glutamine, which means that if TG is the crosslinking agent then the protein source must be checked for lysine and glutamine content. As noted above, soy flour is an excellent source for both lysine and glutamine, and can be used in most situations. Abattoir blood is an excellent source of lysine. Combined with glutamine which is endogenous to most oilseeds, this can be an effective combination. Whey protein is also an excellent source of exogenous protein with an advantageous profile of amino acids, as is defatted flax flour.

Another factor to consider with respect to protein is the quality of the selected protein. Prior to crosslinking, the proteins need to be in as natural and soluble state as possible. Solubility provides availability of proteins for maximum crosslinking activity.

Dispersability is an additional factor to consider when selecting a protein. The protein should be in a particular physical state such that it intersperses well in the mixture to consistent provide a relatively homogenous, and/or uniform protein matrix. The concepts of solubility and dispersion are corollaries, leading to the same result, which is a high quality protein matrix to protect the lipids and other bioactive aliments.

Another factor to consider is the use of a combination of exogenous proteins. For example, a combination of soy flour and abattoir blood could be utilized with pulverized whole sunflower seed.

If a high level of ruminal protection is necessary, the ratio of protein to lipid can be increased.

Step 1d—Determine the Amount of Crosslinking Agent.

A crosslinking agent may be selected that enable the proteinaceous material to be enzymatically cross-linked in a matrix. Various crosslinking agents have effectiveness curves and measures unique to the agents that permit them to be optimized accordingly. For example, transglutaminase can be measured in “units”, which are defined by a commercially available activity assay. Anywhere from 2-12 or even more units of activity could be used. Suitable dosages of transglutaminase are 6-12.

Step 1e—Determine the Amount of Water.

Protein crosslinking generally requires water. Crosslinking can be achieved in a wide spectrum of moisture levels. For a composition made of oilseeds and 20% soy flour, a good processing moisture is 39%, although more or less would also work. For efficiency of drying it is better to minimize the amount of water.

Step 2a—Particle Size for Ruminal Protection.

For ruminal protection, one of the key issues to consider is that the product will be fed to an animal who will chew it. Such mastication can break the protective protein matrix or shell. To minimize destruction due to mastication, it is advantageous to use a small particle size. For example, if it is desired to ruminally protect canola oil and the lipid source is canola seed, the size after particle reduction can be designed for survival of mastication. The size and shape of an average canola seed is slightly oblong, about 2 mm in diameter. Cutting canola seed in half and then sealing the cut with exogenous protein and transglutaminase, will protect the half-seed in the rumen environment. Note that the seed coat of a canola seed is substantively undigestible by a ruminant and if unbroken the seed coat provides ruminal protection and will prevent the seed from ever digesting inside the cow. However, due to the relatively large size and lack of structural integrity of the half-seed, it is likely to be crushed during mastication. If crushed, the ruminal protection is mostly lost. But if the canola seed is pulverized to a small particle size, then it is much less likely to be crushed during mastication, due to two reasons: 1) ruminant teeth are imperfect and do not crush all small particles, and 2) it requires more compression to break a small particle versus a larger particle.

Step 2b—Dispersion.

The proteins and other ingredients should be well interspersed prior to application of the crosslinking agent.

Step 2c—Heating.

Under the present disclosure, heating during processing is optional. Sufficient crosslinking can usually be achieved under ambient or even refrigerated temperatures. It just takes more time.

Different protein crosslinking agents have different efficiency curves based on time and temperature. Generally, heating should maximize the efficiency curve. The substrates should be gently heated to the desired temperature, so as to maintain protein quality prior to crosslinking. Furthermore, overheating can inactivate enzymatic crosslinking agents.

Heating can be done either before or after the substrates are mixed, and can be done before or after the crosslinking agent is added provided that the heating is gentle enough to not disrupt the action of the crosslinking agent.

Step 3—Mixing and Crosslinking Proteins

The substrate mixing can take place either before or after water is added, although it is generally preferable to mix the substrates prior to adding water. One reason for adding water last is that the crosslinking agent can be mixed into the water, which provides optimal dispersion.

Step 3a—Special Handling Cases

Air and oxygen can be entrained in the protein matrix. Entrained oxygen can cause deterioration of otherwise protected lipids and bioactive aliments. Under the present disclosure, there are a few ways to handle this issue. One is to include antioxidants or other preservatives in the recipe. Another is to mix the substrates and perform the crosslinking under vacuum, or in a nitrogen atmosphere.

In many embodiments some lipids or other additives are exposed even after the initial crosslinking. This exposure can be reduced through use of a second coating using additional proteins and crosslinking agent(s). Third, fourth, or more coatings may be utilized if desired or necessary.

Step 3b—Dwell Time

Most crosslinking agents have an activity curve that is defined by time and temperature. It is generally necessary to have a dwell time after the crosslinking agent has been added for more complete formation of protein crosslinks. The dwell time is determined by the activity curve of the specific crosslinking agent.

Step 4—Form and Dry

After mixing and crosslinking, the mixture will generally be in a state of being paste or dough. This paste or dough can be extruded into noodles or pellets, partitioned into crumbles, or other such formation prior to drying. The form factor is not critical to the present disclosure, but will affect drying efficiency, handling, transportation, and animal acceptance. Dwell time can be provided for after the dough or paste has been formed or partitioned.

Drying can be performed by any number of conventional methods such as forced air belt drying, infra-red, convection, etc. The product temperature should reach about 95° C. at some point, which will assist with denaturing some proteins to provide a boost to ruminal bypass. Furthermore, the heat will denature crosslinking enzymes and terminate crosslinking activity, which at this point is a desired result. The temperature generally should not go above about 105° C. because proteins, lipids, and other bioactive aliments can be unnecessarily degraded at high temperatures. However, the present disclosure is not negated if temperatures fall outside these described parameters.

### Impact of Disclosed Compositions

Lipids have about twice the caloric value per gram as either carbohydrates or protein, and due to the rumen bypass nature of the present invention, it can be used to increase calorie intake for high producing cows. This is a significant advantage to producers. Currently calcium salts of fatty acids can be offered to increase calorie load, but due to the unpalatability of calcium salts cows often refuse such feed. The compositions disclosed herein provide the needed calories in a product that cows find highly palatable.

It is known that more omega 3's in the diet help cows to get pregnant and hold the pregnancy. Pregnancy rates are one of the most important factors for a successful dairy. Most existing rations provide too much omega 6 and not enough omega 3. Ideally, the feed composition balances the ratio of omega 6 to omega 3 so that cows can get pregnant and hold the pregnancy. Other health benefits also accrue from having a balanced dietary lipid profile, especially in regard to immune system function.

When discussing ruminants and omega 3 lipids it is important to understand that the cow (or other ruminant) will convert some ALA into other omega 3 fats such as EPA (20:5 n3) and DPA (22:5 n3). These omega 3's will add slightly to the total omega 3 available in milk or meat. Example 1 below reports on an inventive composition that was tested at the University of Idaho and shown to have ALA in milkfat at 2.77%. When the total milkfat profile is known, it is expected to show that when the ALA is at 2.77%, the total omega 3 will be slightly above 3%.

The significance of this advancement can be demonstrated by examining how a one ounce serving of cheddar cheese can be improved. In a one ounce serving of cheese (one ounce equals 28.35 grams) there are about 9 grams of fat. Cheese made with regular milk will supply 45 milligrams of omega 3 (9,000 mg of fat times 0.5% ALA). The US Daily Value (DV) of omega 3 for a female is 1,100 mg, and for a male is 1,600 mg. Thus, regular cheese would supply a female with 4.1% of omega 3 DV, and for a male 2.8%. If cheese is made from improved milk using the present disclosure, the amount of omega 3 supplied in one ounce of cheese increases to 270 mg (9,000 mg of fat times 3%), or 24.5% of DV for a female, and 16.9% for a male. Thus the present disclosure changes dairy products from an insignificant source of omega 3 to a major source.

### Examples of the Disclosed Embodiments

The following are several examples of feed compositions and methods for preparing the feed compositions. Such exemplary formulations and manufacturing conditions are given by way of example, and not by limitation, in order to illustrate compositions that have been found to be useful. Examples that were actually made are set forth in past tense (Examples 1-4), while hypothetical examples (Examples 5-12) are set forth in present tense. Unless otherwise indicated, all percentages are by weight.

Examples 1 through 4 were designed to increase the amount of omega 3 in the milkfat. Example 5 is designed to be fed to lactating cows during times of peak lactation or during times of heat or cold stress. The needed characteristics of feed during peak lactation include, among other things, caloric density to support high milk production, and lipid profile balance to support pregnancy.

### Example 1

Pulverized flaxseed was used as 80% of the substrate, dry matter basis. Pulverization resulted in 65% of the pulverized flax passing through a US Standard Sieve number 40 (0.425 mm), and 95% passing through a sieve number 20 (0.85 mm). Soy flour was used as 20% of the substrate, dry matter basis. The soy flour was PDI 90, mesh 100 (Honey Soy from CHS Cooperative, Mankato, Minn.). Transglutaminase was applied at 12 units of activity per gram of protein. Processing moisture was targeted at 39% of total wet weight. Dwell time was 12 hours after application of transglutaminase.

The pulverized flaxseed was heated to 50° C. using microwave. Ambient temperature soy flour (21° C.) was mixed with the flaxseed until well dispersed. Water was heated to 50° C. and mixed with transglutaminase. Then the water and transglutaminase was mixed with the dry ingredients until the dough was consistent. The dough was given 12 hours of dwell time, after which it was formed into noodles through 4 mm die size. Drying was done on a forced air dryer with air temp of 95° C. and product temp of 95° C. for 5 minutes at the end. Moisture level after drying was 6%.

Example 1 discloses the formula used in an experiment performed in 2016 at the University of Idaho in which 8 mid-lactation cows were divided into 4 groups of 2 each. A latin square design was employed and the treatments were control (zero supplement), 2 lbs per day of supplement, 4 lbs per day of supplement, and 6 lbs per day of supplement.

The means of ALA in the milkfat were 0.53, 1.43, 2.14 and 2.77 for 0, 2, 4 and 6 pounds, respectively. Efficiency of transfer has not yet been fully determined but it is expected to be about 10%. The results of this study are still being calculated and organized and will be published in a peer reviewed periodical.

Compared to the results shown in Table 1, the results of Example 1 are remarkably higher than any currently available treatment can achieve. Whereas with existing treatments total ALA in milkfat can increase a maximum of 0.9% to a limit of 1.3%, Example 1 establishes that ALA in milkfat increases 2.24% to a total of 2.77%.

### Example 2

Pulverized flaxseed was used as 83% of the substrate, dry matter basis. Pulverization resulted in 32% of the pulverized flax passing through a US Standard Sieve number 40 (0.425 mm), and 67% passing through a sieve number 20 (0.85 mm). Soy flour was used as 17% of the substrate, dry matter basis. The soy flour was PDI 90, mesh 100 (Honey Soy from CHS Cooperative, Mankato, Minn.). Transglutaminase was applied at 8 units of activity per gram of protein. Processing moisture was targeted at 42% of total wet weight. Dwell time was 2 hours after application of transglutaminase.

The pulverized flaxseed was heated to 50° C. using microwave. Ambient temperature soy flour (21° C.) was mixed with the flaxseed until well dispersed. Water was heated to 50° C. and mixed with transglutaminase. Then the water and transglutaminase was mixed with the dry ingredients until the dough was consistent. The dough was given 2 hours of dwell time, after which it was formed into noodles through 4 mm die size. Drying was done on a forced air dryer with air temp of 95° C. and product temp of 95° C. for 5 minutes at the end. Moisture level after drying was 6%.

Example 2 discloses the formula used in a first dairy test at the University of Idaho, which was performed in early 2015. The test was a short and simple test in which 4 mid-lactation cows were fed a control diet (normal mixed ration) for a week, then they were fed the supplement of described above Embodiment 2 for a week at a rate of 2 lbs per day in addition to their normal mixed ration. At the end of each week milk samples were taken and milkfat profile was determined. Results were as follows:

| | Control: | Supplement: | |
|---|---|---|---|
| Cow # | ALA % in | ALA % in | Increase in ALA, |
| (midlactation) | Milkfat | Milkfat | based on 2 lbs |
| 2642 | 0.48 | 1.59 | 1.11 |
| 2654 | 0.49 | 1.75 | 1.26 |
| 2655 | 0.50 | 1.70 | 1.20 |
| 2656 | 0.55 | 2.09 | 1.54 |
| Average | 0.51 | 1.78 | 1.27 |

Given the low inclusion rate (2 lbs per day) these results were striking and clearly demonstrated a marked improvement over anything currently available.

### Example 3

Pulverized flaxseed was used as 83% of the substrate, dry matter basis. Pulverization resulted in 32% of the pulverized flax passing through a US Standard Sieve number 40 (0.425 mm), and 67% passing through a sieve number 20 (0.85 mm). Soy flour was used as 17% of the substrate, dry matter basis. The soy flour was PDI 90, mesh 100 (Honey Soy from CHS Cooperative, Mankato, Minn.). Transglutaminase was applied at 8 units of activity per gram of protein. Processing moisture was targeted at 35% of total wet weight. Dwell time was 30 minutes after application of transglutaminase.

The pulverized flaxseed was heated to 50° C. using microwave. Ambient temperature soy flour (21° C.) was mixed with the flaxseed until well dispersed. Water was heated to 50° C. and mixed with transglutaminase. Then the water and transglutaminase was mixed with the dry ingredients until the dough was consistent. The dough was given 30 minutes of dwell time, after which it was formed into noodles through 4 mm die size. Drying was done on a forced air dryer with air temp of 95° C. and product temp of 95° C. for 5 minutes at the end. Moisture level after drying was 6%.

Below are results for a second dairy test at the University of Idaho over four weeks in which 4 cows were fed the formula from this example.

| Week & Treatment | | | | | | | |
|---|---|---|---|---|---|---|---|
| | Week 0 | Week 1 | Week 2 | Week 3 | Week 4 | Supplement | Base Ration |
| | 0 lbs | 0 lbs | 2 lbs | 4 lbs | 6 lbs | / | / |
| Milk Yield | 80.80 | 90.88 | 81.73 | 88.30 | 93.70 | / | |
| (lbs) | | | | | | | |
| Fat | 1.66 | 1.69 | 1.34 | 1.80 | 1.54 | / | / |
| Protein | 3.16 | 3.10 | 3.21 | 2.90 | 3.31 | / | / |
| Lactose | 4.88 | 4.92 | 4.95 | 4.59 | 4.96 | / | / |
| SNF | 9.03 | 9.00 | 9.13 | 8.47 | 9.28 | / | / |
| MUN | 14.50 | 11.90 | 12.35 | 10.97 | 13.33 | / | / |
| Feed Intake | 37.00 | 88.29 | 95.30 | 98.24 | 103.11 | / | / |
| (lbs) | | | | | | | |
| 4:0 (%) | 2.39 | 2.41 | 2.36 | 2.56 | 2.20 | 0 | 0 |
| 6:0 (%) | 1.46 | 1.54 | 1.62 | 1.72 | 1.54 | 0 | 0 |
| 8:0 (%) | 0.90 | 0.97 | 1.07 | 1.17 | 1.08 | 0 | 0 |
| 10:0 (%) | 2.07 | 2.27 | 2.49 | 2.76 | 2.38 | 0 | 0 |
| 12:0 (%) | 2.47 | 2.63 | 2.88 | 3.19 | 2.71 | 0 | 0.08 |
| 14:0 (%) | 8.93 | 9.63 | 9.87 | 10.26 | 8.75 | 0.08 | 0.28 |
| 14:1 (%) | 1.21 | 1.26 | 1.30 | 1.25 | 1.16 | 0 | 0 |
| 15:0 (%) | 0.71 | 0.81 | 0.77 | 0.82 | 0.72 | 0 | 0.12 |
| 16:0 (%) | 28.78 | 25.96 | 24.22 | 23.13 | 19.23 | 5.76 | 16.36 |
| 16:1 c9 (%) | 1.41 | 1.20 | 1.29 | 0.91 | 0.88 | 0.06 | 0.29 |
| 17:0 (%) | 0.48 | 0.57 | 0.53 | 0.50 | 0.47 | 0.08 | 0.12 |
| 18:0 (%) | 10.10 | 11.95 | 12.58 | 13.00 | 12.89 | 3.97 | 2.22 |
| 18:1 t9 (%) | 0.42 | 0.35 | 0.47 | 0.40 | 0.52 | 0 | 0 |
| 18:1 t10 (%) | 1.22 | 0.61 | 0.99 | 0.72 | 1.04 | 0 | 0 |
| 18:1 t11 (%) | 2.32 | 2.47 | 2.22 | 2.16 | 3.95 | 0 | 0 |
| 18:1 c9 (%) | 24.96 | 25.13 | 25.48 | 24.29 | 25.36 | 19.54 | 21.93 |
| 18:2 c9c12 (%) | 4.51 | 4.50 | 4.42 | 4.10 | 5.69 | 15.50 | 46.78 |
| 18:2 c9t11 (%) | 1.31 | 1.24 | 1.19 | 1.09 | 1.94 | 0.60 | 0.38 |
| 18:3n3 (%) | 0.40 | 0.49 | 0.96 | 1.44 | 1.92 | 52.83 | 7.71 |

The 4 cows, which were mid-lactation cows, were fed at rates of 0, 2, 4, and 6 lbs per day. This second dairy test at the University of Idaho was also performed in 2015.

ALA in milkfat for 18:3n3 increased from an average of 0.49% to 1.92% when inclusion rates were 6 lbs per day. While this improvement was not as remarkable as the results in the other two tests performed at the University of Idaho, they still show significantly better results than any other available treatment. It can be hypothesized that the less stellar results are due to two issues in the production formula: 1) less water in the production formula, and 2) reduced dwell time.

### Example 4

Pulverized flaxseed was used as 83% of the substrate. Pulverization resulted in 32% of the pulverized flax passing through a US Standard Sieve number 40 (0.425 mm), and 67% passing through a sieve number 20 (0.85 mm). Soy flour was used as 17% of the substrate. The soy flour was PDI 90, mesh 100 (Honey Soy from CHS Cooperative, Mankato, Minn.). Transglutaminase was applied at 8 units of activity per gram of protein. Processing moisture was targeted at 42% of total wet weight. Dwell time was 2 hours after application of transglutaminase after which the dough was noodled and dried.

The pulverized flaxseed was heated to 50° C. using microwave. Ambient temperature soy flour (21° C.) was mixed with the flaxseed until well dispersed. Water was heated to 50° C. and mixed with transglutaminase. Then the water and transglutaminase was mixed with the dry ingredients until the dough was consistent. The dough was given 2 hours of dwell time, after which it was formed into noodles through 3.5 mm die size. Drying was done on in a convection oven with air temp of 95° C. Moisture level after drying was 6%.

Example 4 discloses the formula used in an experiment performed at the US Department of Agriculture—Agricultural Research Service (USDA-ARS) in Mandan, N. Dak. In this experiment two groups of 15 steers each were raised on pasture supplemented with 2 lbs per day of either ground flaxseed (positive control) or 2 lbs per day of the composition in Example 4. The steers were taken to slaughter and samples of subcutaneous fat were taken, along with muscle samples. Blood samples were taken at various times during the study. The pasture based diet did not supply the steers with sufficient caloric intake to maximize their genetic potential. They were thin, generally, and did not grade well at slaughter. This may have caused issues in relation to lipid metabolism, so the conclusions we can draw are limited.

The mean ALA in the subcutaneous fat of the positive control group (ground flaxseed) was 0.709%. The mean ALA in the fat of the experimental group using the composition from Example 4 was 1.027%. The results clearly support the conclusion that the composition in Example 4 was significantly better than ground flaxseed. This USDA-ARS study will be submitted for publication when blood and muscle phospholipid data are received and organized.

### Example 5

Pulverized flaxseed is used as 14% of the substrate. Pulverized canola is used as 66% of the substrate. Pulverization results in 65% of the pulverized seeds passing through a US Standard Sieve number 40 (0.425 mm), and 95% passing through a sieve number 20 (0.85 mm). Soy flour is used as 20% of the substrate. The soy flour is PDI 90, mesh 100 (Honey Soy from CHS Cooperative, Mankato, Minn.). Transglutaminase is applied at 10 units of activity per gram of protein. Processing moisture is targeted at 40% of total wet weight. Dwell time is 2 hours after application of transglutaminase, after which the dough is noodled and dried.

The pulverized seeds are heated to 50° C. using microwave. Ambient temperature soy flour (21° C.) is mixed with the pulverized flax and canola until well dispersed. Water is heated to 50° C. and mixed with transglutaminase. Then the water and transglutaminase is mixed with the dry ingredients until the dough is consistent. The dough is given 2 hours of dwell time, after which it is formed into noodles through 4 mm die size. Drying is done on in a forced air belt dryer and product temperatures are maintained at 95° C. or less during drying, with product temp reaching 95° C. for at least 5 minutes. Moisture level after drying is 6%.

Example 5 is designed to be fed to lactating cows during times of peak lactation or during times of heat or cold stress. The needed characteristics of feed during peak lactation include, among other things, caloric density to support high milk production, and lipid profile balance to support pregnancy.

As indicated above, it is known that more omega 3's in the diet help cows to get pregnant and hold the pregnancy. Pregnancy rates are one of the most important factors for a successful dairy. While most existing rations provide too much omega 6 and not enough omega 3, the composition of Example 5 balances the ratio of omega 6 to omega 3 so that cows can get pregnant and hold the pregnancy. As also indicated above, other health benefits also accrue from having a balanced dietary lipid profile, especially in regard to immune system function.

During times of heat or cold stress cows will often reduce feed intake. Therefore, what is needed is a feed that simply provides more caloric density. The composition of Example 5 provides the necessary caloric density, with the added benefits of palatability and generally improved lipid profile.

### Example 6

Pulverized canola is used as 80% of the substrate. Pulverization results in 65% of the pulverized canola passing through a US Standard Sieve number 40 (0.425 mm), and 95% passing through a sieve number 20 (0.85 mm). Soy flour is used as 20% of the substrate. The soy flour is PDI 90, mesh 100 (Honey Soy from CHS Cooperative, Mankato, Minn.). Transglutaminase is applied at 10 units of activity per gram of protein. Processing moisture is targeted at 40% of total wet weight. Dwell time is 2 hours after application of transglutaminase, after which the dough is noodled and dried.

The pulverized seeds are heated to 50° C. using microwave. Ambient temperature soy flour (21° C.) is mixed with the pulverized flax and canola until well dispersed. Water is heated to 50° C. and mixed with transglutaminase. Then the water and transglutaminase is mixed with the dry ingredients until the dough is consistent. The dough is given 2 hours of dwell time, after which it is formed into noodles through 4 mm die size. Drying is done on in a forced air belt dryer and product temperatures are maintained at 95° C. or less during drying, with product temp reaching 95° C. for at least 5 minutes. Moisture level after drying is 6%.

Like the composition of Example 5, the composition of Example 6 also provides the necessary caloric density, with the added benefits of palatability and generally improved lipid profile.

### Example 7

Similar to Example 6 except that another oilseed, such as sunflower, safflower, cottonseed, soy, camelina, etc. is used instead of flaxseed.

### Example 8

Similar to Example 5 except that a customized mixture of oilseeds is used, such that the resulting lipid profile is customized as desired.

### Example 9

Similar to Example 5 except that porcine, poultry, bovine or other abattoir blood is used instead of soy flour as the exogenous protein.

### Example 10

Similar to Example 5 except that a mixture of soy flour and abattoir blood is used as the exogenous proteins.

### Example 11

Algae is used as 60% of the substrate. Soy flour is used as 40% of the substrate. The soy flour is PDI 90, mesh 100 (Honey Soy from CHS Cooperative, Mankato, Minn.). Transglutaminase is applied at 12 units of activity per gram of protein. Processing moisture is targeted at 40% of total wet weight. Dwell time is 2 hours after application of transglutaminase, after which the dough is noodled and dried.

The algae is heated to 50° C. using microwave. Ambient temperature soy flour (21° C.) is mixed with the pulverized flax and canola until well dispersed. Water is heated to 50° C. and mixed with transglutaminase. Then the water and transglutaminase is mixed with the dry ingredients until the dough is consistent. The dough is given 2 hours of dwell time, after which it is formed into noodles through 3 mm die size. Drying is done in a forced air belt dryer and product temperatures are maintained at 95° C. or less during drying, with product temp reaching 95° C. for at least 5 minutes.

### Example 12

Algae is used as 22% of the substrate. Pulverized flaxseed is used as 45% of the substrate. Pulverization results in 65% of the pulverized flax passing through a US Standard Sieve number 40 (0.425 mm), and 95% passing through a sieve number 20 (0.85 mm). Soy flour is used as 33% of the substrate. The soy flour is PDI 90, mesh 100 (Honey Soy from CHS Cooperative, Mankato, Minn.). Transglutaminase is applied at 12 units of activity per gram of protein. Processing moisture is targeted at 40% of total wet weight. Dwell time is 2 hours after application of transglutaminase, after which the dough is noodled and dried.

The algae and the flaxseed are heated to 50° C. using microwave. Ambient temperature soy flour (21° C.) is mixed with the pulverized flax and canola until well dispersed. Water is heated to 50° C. and mixed with transglutaminase. Then the water and transglutaminase is mixed with the dry ingredients until the dough is consistent. The dough is given 2 hours of dwell time, after which it is formed into noodles through 4 mm die size. Drying is done on a forced air belt dryer and product temperatures are maintained at 95° C. or less during drying, with product temp reaching 95° C. for at least 5 minutes.

### Example 13

In this Example, pulverized flaxseed was used as 71% of the substrate, on a dry matter basis. Soy flour was used as 29% of the substrate, also on a dry matter basis. The soy flour was PDI 90, mesh 100 (Honey Soy from CHS Cooperative, Mankato, Minn.). Transglutaminase (Kinry TG-H2000, 2000 units of activity per gram) was applied to the flaxseed/soy flour mixture at 12 units of activity per gram of protein. Processing moisture was targeted at approximately 41% of total wet weight. Dwell time was 12 hours after application of transglutaminase.

The pulverized flaxseed was heated to 50° C. using microwave. Following heating, ambient temperature soy flour (21° C.) was mixed with the flaxseed until well dispersed. Water was heated to 40° C. and mixed with transglutaminase. Following this, the water and transglutaminase were mixed with the dry ingredients until the dough was consistent. The dough was given 12 hours of dwell time, after which it was formed into noodles through a 2 mm die. Drying was done with a forced air dryer with air temp of approximately 95° C. Moisture level after drying was about 6%.

Feed formed using this formula was then used in two experiments performed at Oregon State University (OSU). The first experiment was a simple stepped-dose trial for 6 Holsteins. The Holsteins were fed zero supplement for one week (week zero), then two lbs of supplement daily for one week, then 4 lbs of supplement daily for two weeks, then 6 lbs of supplement daily for 2 weeks. Milk and blood samples were taken at the end of each feeding level. DMI (Dry Matter Intake) and other production parameters such as Milk Yield and Milkfat percent were also tracked. Results were as follows:

| | Milkfat ALA | DMI | Milk Yield | Milkfat |
|---|---|---|---|---|
| Supplement | % | (kg) | (kg) | % |
| Base, or zero | 0.37 | 18.4 | 20.7 | 3.96 |
| 2 lbs | 1.64 | 17.5 | 20.9 | 4.11 |
| 4 lbs | 2.23 | 16.4 | 21.4 | 4.69 |
| 6 lbs | 2.77 | 20.9 | 22.8 | 4.06 |

The second experiment was a Latin Square trial in which the supplement was compared to a positive control consisting of ground flaxseed mixed with soybean meal in equal ratio as the treated supplement. There was no washout period between treatments, which skewed milkfat omega 3 upward for zero supplement and the positive control.

Results are as follows:

| | Milkfat | Milk Yield |
|---|---|---|
| Feed | n3% | (kg) |
| Base, or zero | 1.07% | 27.27 |
| 6 lbs positive control | 1.49% | 30.59 |
| (ground flax) | | |
| 6 lbs supplement | 2.32% | 30.38 |

### Scope of the Disclosure

It will be understood by those having skill in the art that changes may be made to the details of the above-described embodiments without departing from the underlying principles presented herein. For example, any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

References to approximations are made throughout this specification, such as by use of the terms “about” or “approximately.” For each such reference, it is to be understood that, in some embodiments, the value, feature, or characteristic may be specified without approximation. For example, where qualifiers such as “about,” “substantially,” and “generally” are used, these terms include within their scope the qualified words in the absence of their qualifiers.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, FIGURE, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the preceding claims up to and including claim [x],” where the bracketed term “[x]” is replaced with the number of the most recently recited independent claim. For example, for the first claim set that begins with independent claim 1, claim 3 can depend from either of claims 1 and 2, with these separate dependencies yielding two distinct embodiments; claim 4 can depend from any one of claim 1, 2, or 3, with these separate dependencies yielding three distinct embodiments; claim 5 can depend from any one of claim 1, 2, 3, or 4, with these separate dependencies yielding four distinct embodiments; and so on.

Recitation in the claims of the term “first” with respect to a feature or element does not necessarily imply the existence of a second or additional such feature or element. Embodiments of the invention in which an exclusive property or privilege is claimed are defined as follows.

1. A method of preparing a ruminally protected composite material, the method comprising:
pulverizing a lipid-bearing material, which includes lipids;
mixing a proteinaceous material, which includes proteins, an enzymatic protein crosslinking agent, and the pulverized lipid-bearing material to yield a mixture;
molding the mixture to yield feed in a physical form factor conducive to drying, transport, storage, and feeding;
wherein the form feed has a matrix configured such that the lipid-bearing material is at least partially entrained within the matrix and such that a portion of the lipids in the lipid-bearing material is protected from ruminal degradation; and
drying the feed.

2-8. (canceled)

9. The method of claim 1, wherein pulverizing a lipid-bearing material enables a majority of the pulverized lipid-bearing material to pass through a sieve having 0.6 mm openings and at least about 95% of the pulverized lipid-bearing material to pass through a sieve having 1.18 mm openings.

10. The method of claim 1, wherein the lipids and the proteins are present in a ratio ranging from about 2:1 of lipid to protein to about 1:10 lipid to protein.

11. The method of claim 1, wherein the proteinaceous material is exogenous to the lipid-bearing material.

12. The method of claim 1, wherein the lipid-bearing material and proteinaceous material come from a single source that is at least one of an oilseed, phytoplankton, algae, fish, krill, marine offal, or animal offal.

13. The method of claim 1, wherein the lipid-bearing material is at least one of phytoplankton, algae, fish, krill, marine offal, animal offal.

14. The method of claim 1, wherein the lipid-bearing material is an oilseed.

15. The method of claim 14, wherein the oilseed is at least one of soya bean, flax, safflower, sunflower, rapeseed, canola, mustard seed, camelina, nuts, peanuts, hemp, chia, or echium.

16. The method of claim 1, wherein the proteinaceous material is at least one of algae, phytoplankton, blood, offal, feathers, meat meal, legumes, alfalfa, or gelatin.

17. The method of claim 1, wherein the proteinaceous material is an oilseed.

18. The method of claim 17, wherein the oilseed is at least one of soya bean, flax, safflower, sunflower, rapeseed, canola, mustard seed, camelina, nuts, peanuts, hemp, chia, or echium.

19. The method of claim 1, wherein the crosslinking agent is transglutaminase.

20. The method of claim 1, wherein the crosslinking agent is at least one of protein disulphide isomerase, protein disulphide reductase, sulphydryl oxidase, lysyl oxidase, peroxidase, or glucose oxidase.

21. A ruminant animal feed comprising:
a proteinaceous material; and
a lipid-bearing material that includes lipids;
wherein the proteinaceous material includes enzymatically cross-linked and denatured proteins in a matrix,
wherein the lipids and the proteins are present in a ratio ranging from about 2:1 of lipid to protein to about 1:10 lipid to protein,
wherein the lipid-bearing material and the proteinaceous material are intermixed such that the lipid-bearing material is at least partially contained within the matrix and such that a portion of the lipids in the lipid-bearing material is protected from ruminal degradation.

22. The feed of claim 21, wherein the lipid-bearing material and proteinaceous material come from a single source that is at least one of an oilseed, phytoplankton, algae, fish, krill, marine offal, or animal offal.

23-32. (canceled)

33. The feed of claim 21, wherein the crosslinking agent is transglutaminase.

34. The feed of claim 21, wherein the crosslinking agent is at least one of protein disulphide isomerase, protein disulphide reductase, sulphydryl oxidase, lysyl oxidase, peroxidase, or glucose oxidase.

35-36. (canceled)

37. A method of modifying the fatty acid profile in milkfat, comprising feeding a ruminant the feed recited in claim 21.

38. A method as recited in claim 37, wherein the ruminant yields omega 3 as a percent of milkfat that is at least one of greater than about 1-.3%, greater than about 2%, greater than about 2.5%, or at least about 3%.

39. A method of modifying the fatty acid profile in meat or fat comprising feeding a ruminant the feed recited in claim 21.
